(19) United States
(12) Patent Application Publication
(10) Pub. No.: US 2006/0203305 A1
(43) Pub. Date: Sep. 14, 2006

(54) Sensor alignment method using in a scanning apparatus

(76) Inventors: Chih-Hsien Chang, Hsinchu (TW); Yu-Da Chen, Hsinchu (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/076,931

(22) Filed: Mar. 11, 2005

(51) Int. Cl. H04N 1/04

(52) U.S. Cl. 358/497; 358/474

(57) ABSTRACT

The present invention provides a sensor alignment method using in a scanning apparatus. Firstly, providing a housing on the transparent board and defining a alignment area below the housing, the sensor locates under the alignment area and the light source locates aside the alignment area; then, moving the sensor out of underside of the alignment area and measuring intensity of light source to obtain a regional position where the brightest position on the transparent board, and moving the sensor to underside of the regional position; and finally, moving the sensor and the light source into the alignment area, and synchronously moving the sensor and the light source out to capture images. This invention prevents the tolerance formed in the printing process and the alignment point determination of the sensor is more precise, and furthermore, the scanning area is increased and the manufacturing cost is reduced.

### BACKGROUND OF INVENTION

1. Field of the Invention

The invention relates to an alignment method, and more particularly, to a sensor alignment method using in a scanning apparatus that can increase the scanning area and reduce the glass printing cost.

2. Description of the Prior Art

Scanner is an apparatus for capturing images and can be classified into flatbed scanner and transmission scanner. The flatbed scanner is used for scanning opaque manuscripts, such as photographs and printings. The principle of capturing images is that the light firstly irradiates the opaque manuscript and the dark or bright portions on the manuscript reflect different intensities of light, the charge coupled devices in the scanner transfer these reflective light with different intensities into different digital data, and the software for controlling the scanner eventually reads and recombines these digital data into image files. The other one is transmission scanner, which is specially used for scanning transparent manuscripts, such as slides and negatives, and having great performance.

Please refer to FIGS. 1A to 1C. The glass 10 of conventional scanner is generally designed an alignment line 12 on one side of the housing 13. The alignment line 12 is used for initializing and calibrating the sensor 14. While progressing, the sensor 14 firstly measures intensity of the light source 16, and then moves from the alignment line 12 back to the brightest position of the light source 16 to perform scanning. However, this kind of design occupies scanning area and increases manufacturing cost by printing the alignment line on the glass. In addition, the sensor 14 may wrongly determine the alignment point by the error of the alignment line 12 caused by the tolerance in printing process. The above problems already exist for a long time, and solutions are deeply required.

### SUMMARY OF INVENTION

It is therefore a primary objective of the claimed invention to provide a sensor alignment method using in a scanning apparatus that can increase the scanning area without designing any alignment line on the glass.

It is therefore another objective of the claimed invention to provide a sensor alignment method using in a scanning apparatus that need not design any alignment line and therefore can omit the glass printing process and reduce the manufacturing cost.

It is therefore a further objective of the claimed invention to provide a sensor alignment method using in a scanning apparatus that can prevent the tolerance formed in the printing process, and the alignment point determination of the sensor can be more precise.

According to the claimed invention, steps of a sensor alignment method using in a scanning apparatus includes providing a housing deposed on a transparent board and defining an alignment area below the housing, the sensor locates under the alignment area and the light source locates aside the alignment area; then, moving the sensor out of underside of the alignment area and measuring intensity of the light source to obtain a regional position where the brightest position on the transparent board, and moving the sensor to underside of the regional position after measuring; and finally, correspondingly moving the sensor and the light source into the alignment area, and synchronously moving the sensor and the light source out subsequently to capture images.

These and other objectives of the present invention will no doubt become obvious to those of ordinary skill in the art after reading the following detailed description of the preferred embodiment that is illustrated in the various figures and drawings.

### BRIEF DESCRIPTION OF DRAWINGS

FIGS. 1A to 1C are diagrams showing steps of sensor alignment according to the prior art.

FIGS. 2A to 2D are diagrams showing steps of sensor alignment according to the present invention.

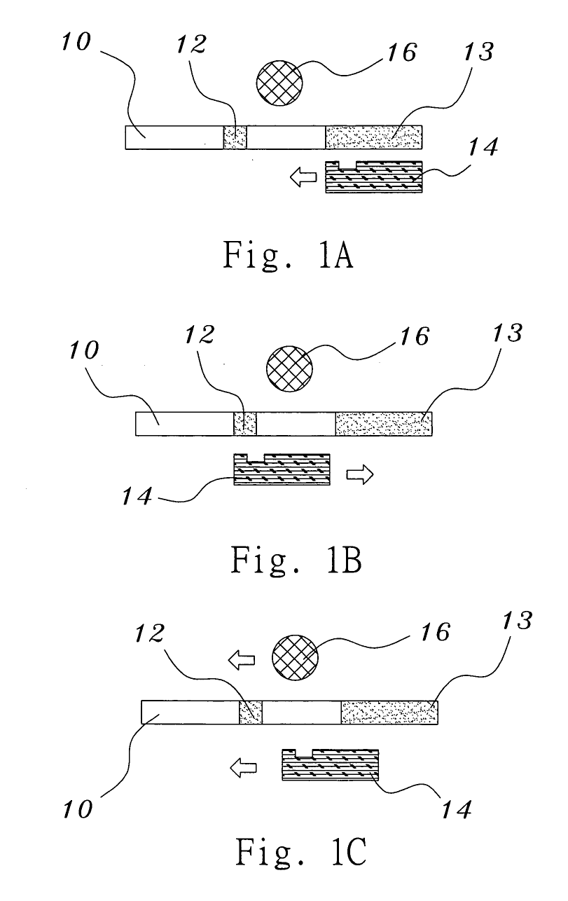

| | | | |
|---|---|---|---|
| 10 | glass | 12 | alignment line |
| 13 | housing | 14 | sensor |
| 16 | light source board | 20 | transparent |
| 22 | light source | 24 | sensor |
| 26 | alignment area position | 28 | regional |

### DETAILED DESCRIPTION

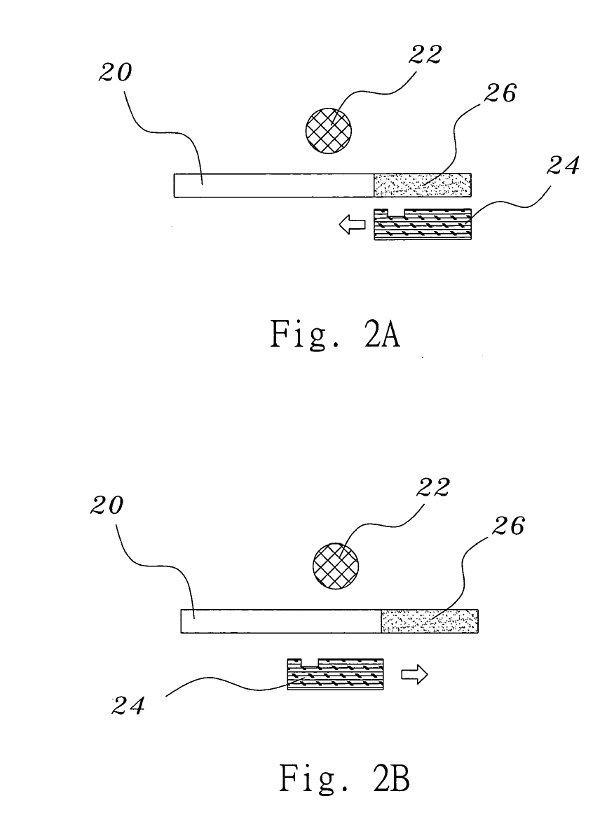

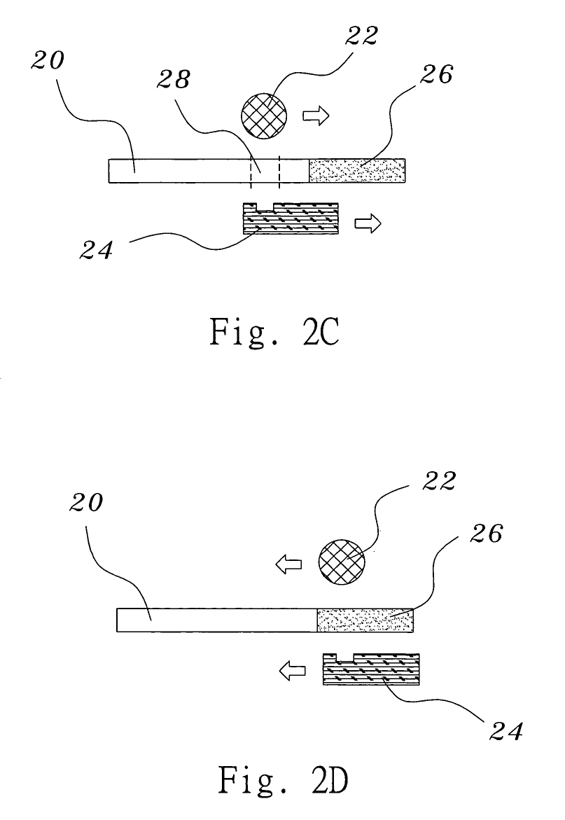

The present invention relates a sensor alignment method using in a scanning apparatus Please refer to FIGS. 2A to 2D. The present alignment method can be applied to the scanning apparatus of transmission type or upper light source type. The scanning apparatus includes a transparent board 20 made by glass material. A movable light source 22 is installed above the transparent board 20, and a movable sensor 24 is deposed under the transparent board 20. The light source 22 is a Cold Cathode Fluorescent Lamp (CCFL), and the sensor is selected from one of Complementary Metal Oxide Semiconductor and Charge Couple Device. The present alignment method firstly defines an alignment area 26 on the surface of transparent board 20. The alignment area 26 is opaque and on the housing of the scanning apparatus, the sensor 24 locates under the alignment area 26, and the light source 22 locates aside the alignment area 26. Then, the sensor 24 is moved out of underside of the alignment area 26 and intensity of the light source 22 is measured to obtain a regional position 28 where the brightest position on the transparent board 20. Wherein the moving distance of the sensor 24 is defined by the operator and at least exceeds the cross-section of the light source. After measuring intensity of the light source 22, the sensor 24 is moved to underside of the regional position 28. Finally, the sensor 24 and the light source 22 are correspondingly moved into the alignment area 26, and subsequently, the sensor 24 and the light source 22 are synchronously moved out to capture images.

In contrast to the prior art, the present invention is utilized to initialize the scanning apparatus while capturing images or calibrate position of the sensor 24, so that the present invention can increase the scanning area of the sensor 24 without designing any alignment line on the transparent board 20. In addition, the alignment line is not required any more, therefore the conventional glass printing process can be omitted and the manufacturing cost can be reduced. The tolerance formed in the printing process can be also prevented, and the alignment point determination of the sensor 24 can be more precise to improve quality of scanned images.

Those skilled in the art will readily observe that numerous modifications and alterations of the device may be made while retaining the teachings of the invention. Accordingly, the above disclosure should be construed as limited only by the metes and bounds of the appended claims.

What is claimed is:

1. A sensor alignment method using in a scanning apparatus, the scanning apparatus includes a transparent board wherein a light source and a sensor are individually and movably located above and below the transparent board, the sensor alignment method comprising steps of:
providing a housing deposed on the transparent board and defining an alignment area below the housing, the sensor locates under the alignment area and the light source locates aside the alignment area;
moving the sensor out of underside of the alignment area and measuring intensity of the light source to obtain a regional position where the brightest position on the transparent board, and moving the sensor to underside of the regional position after measuring; and
correspondingly moving the sensor and the light source into the alignment area, and synchronously moving the sensor and the light source out subsequently to capture images.

2. The sensor alignment method of claim 1, wherein the scanning apparatus is transmission type or upper light source type.

3. The sensor alignment method of claim 1, wherein the light source is cold cathode fluorescent lamp.

4. The sensor alignment method of claim 1, wherein the sensor is selected from one of Complementary Metal Oxide Semiconductor and Charge Couple Device.

5. The sensor alignment method of claim 1, wherein material of the transparent board is glass.

6. The sensor alignment method of claim 1, wherein the alignment area is opaque.

7. The sensor alignment method of claim 1 is capable of applying to initialize the scanning apparatus while capturing images or calibrate position of the sensor.
